(19) United States
(12) Patent Application Publication
(10) Pub. No.: US 2019/0079607 A1
(43) Pub. Date: Mar. 14, 2019

(54) TOUCH DISPLAY DEVICE

(71) Applicant: InnoLux Corporation, Miao-Li County (TW)

(72) Inventors: Ming-Jou TAI, Miao-Li County (TW); Chia-Hao TSAI, Miao-Li County (TW); Huai-Ping HUANG, Miao-Li County (TW); Yi-Hsiu WU, Miao-Li County (TW)

(21) Appl. No.: 16/103,156

(22) Filed: Aug. 14, 2018

(30) Foreign Application Priority Data
Sep. 12, 2017 (CN) 201710816815.0
May 4, 2018 (CN) 201810417436.9

(51) Int. Cl. G06F 3/044; G06F 3/041; G02F 1/1333; G02F 1/1339; G02F 1/1335

(52) U.S. Cl. CPC G06F 3/044; G06F 3/0414; G02F 1/13338; G09G 2310/0264; G02F 1/133512; G06F 2203/04112; G06F 2203/04104; G02F 1/1339

(57) ABSTRACT

A touch display device includes a first substrate, a second substrate, a display medium layer, a driving electrode and a reference electrode. The second substrate is disposed opposite to the first substrate. The display medium layer is disposed between the first substrate and the second substrate. The driving electrode is disposed on the first substrate. The reference electrode is disposed on the second substrate. In a touch time interval of a frame time, the reference electrode is provided with a first reference voltage, and the driving electrode is alternatively provided with a first voltage and a second voltage, wherein the first voltage is greater than the first reference voltage and the second voltage is less than or equal to the first reference voltage.

### BACKGROUND

### 1. Field of the Disclosure

The present disclosure relates to the technical field of touch displays and, more particularly, to a touch display device.

### 2. Description of Related Art

With the rapid advance of electronic technology, various information devices, such as mobile phones, tablet computers, ultra-thin notebooks and satellite navigation systems, are constantly being introduced. In addition to using a keyboard or a mouse for input or operation, the use of touch technology to operate the information device is relatively intuitive and thus becomes very popular. The touch device provides a user-friendly and intuitive input operation interface, so that users of any age can directly select or operate the information device with a finger or a touch pen.

Today's touch technologies mostly belong to multi-touch in a two-dimensional plane. Generally, for example, when a finger touches a display surface, a capacitance value will be changed, and a touch position of the finger can be accurately determined, thereby generating a corresponding touch control function. Besides, in addition to the two-dimensional planar touch technology, several three-dimensional touch methods capable of sensing a pressure force are proposed to sense a pressure force in a direction (Z-axis direction) perpendicular to the display surface.

### SUMMARY

The present disclosure provides a touch display device, which includes a first substrate, a second substrate, a display medium layer, a driving electrode and a reference electrode. The second substrate is disposed opposite to the first substrate. The display medium layer is disposed between the first substrate and the second substrate. The driving electrode is disposed on the first substrate. The reference electrode is disposed on the second substrate. In a touch time interval of a frame time, the reference electrode is provided with a first reference voltage, and the driving electrode is alternatively provided with a first voltage and a second voltage, wherein the first voltage is greater than the first reference voltage and the second voltage is less than or equal to the first reference voltage.

The present disclosure also provides a touch display device, which includes a first substrate, a second substrate, a display medium layer, an active device layer, a spacer unit, and a reference electrode. The second substrate is disposed opposite to the first substrate. The display medium layer is disposed between the first substrate and the second substrate. The active device layer is disposed on the first substrate, and further includes a gate line and a data line. The spacer unit is disposed on the second substrate and overlaps the gate line. The reference electrode is disposed on the second substrate. The reference electrode is adjacent to the spacer unit and overlaps the data line.

Other objects, advantages, and novel features of the disclosure will become more apparent from the following detailed description when taken in conjunction with the accompanying drawings.

### BRIEF DESCRIPTION OF THE DRAWINGS

FIG. 1 is a schematic structural diagram of the touch display device in accordance with the present disclosure;

FIG. 2 is another schematic structural diagram of the touch display device in accordance with the present disclosure;

FIG. 3 is a schematic diagram illustrating the reference electrode and the black matrix layer in accordance with the present disclosure;

FIG. 4 is another schematic diagram illustrating the reference electrode and the black matrix layer in accordance with the present disclosure;

FIG. 5 is a schematic diagram illustrating the reference electrode and the common electrode in accordance with the present disclosure;

FIG. 6 schematically illustrates a first timing diagram for display and touch in accordance with the present disclosure;

FIG. 7 schematically illustrates a second timing diagram for display and touch in accordance with the present disclosure;

FIG. 8 schematically illustrates a third timing diagram for display and touch in accordance with the present disclosure;

FIG. 9 schematically illustrates a fourth timing diagram for display and touch in accordance with the present disclosure;

FIG. 10 schematically illustrates a fifth timing diagram for display and touch in accordance with the present disclosure;

FIG. 11 schematically illustrates a sixth timing diagram for display and touch in accordance with the present disclosure;

FIG. 12 is still another schematic structural diagram of the touch display device in accordance with the present disclosure;

FIG. 13 is still another schematic diagram illustrating the reference electrode and the black matrix layer in accordance with the present disclosure;

FIG. 14 is a schematic diagram illustrating the light shielding lines, the spacer units, the second reference electrodes and the data lines in accordance with the present disclosure;

FIG. 15(A) is a schematic diagram illustrating the arrangement of the second reference electrodes in accordance with an embodiment of the present disclosure;

FIG. 15(B) is a schematic diagram illustrating the arrangement of the second reference electrodes in accordance with another embodiment of the present disclosure; and

FIG. 16 is a diagram illustrating a comparison between the overall impedance and brightness under different arrangements of the second reference electrodes.

### DETAILED DESCRIPTION OF THE EMBODIMENTS

In the following description, various embodiments will be provided to explain the implementation and operation of the display device of the present disclosure. The person skilled in the art of the present disclosure will understand the features and advantages of the present disclosure through these embodiments. Various combinations, modifications, substitutions or adaptations may be realized based on the present disclosure.

Furthermore, the use of the ordinal numbers such as “first”, “second”, etc. in the specification and claims to modify the elements of the claims do not imply that a claimed element is physically provided with an ordinal number. The ordinal numbers do not represent the order between a claimed element and another claimed element, or the order of a manufacturing method. The use of these ordinal numbers is only for clearly distinguishing a claimed element having a certain name from another claimed element having the same name.

In addition, the prepositions mentioned in the present specification and claims, such as “above”, “on”, “upon”, “below”, “beneath” or “under”, may refer to direct contact of two elements, or may refer to indirect contact of two elements.

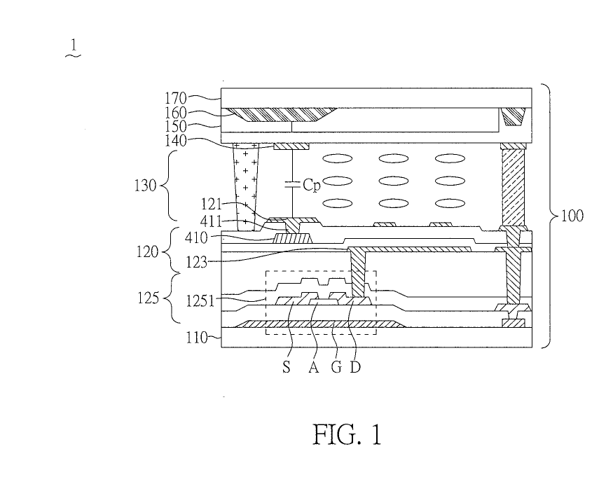

FIG. 1 is a schematic structural diagram of the touch display device 1 in accordance with the present disclosure. In this embodiment, the touch display device 1 includes: a touch display panel 100, in which the touch display panel 100 includes a first substrate 110, an electrode layer 120, an active device layer 125, a display medium layer 130, a reference electrode 140, a color filter layer 150, a black matrix layer 160, and a second substrate 170.

The first substrate 110 is disposed opposite to the second substrate 170. The first substrate 110 and the second substrate 170 are each a rigid substrate or a flexible substrate. The rigid substrate is made of glass, quartz or ceramic. The flexible substrate is made of polyimide (PI), polycarbonate (PC) or polyethylene terephthalate (PET).

The active device layer 125 is disposed on the first substrate 110. The active device layer 125 includes at least one active device 1251 or a plurality of conductive layers. The active device 1251 includes a source S, a drain D, a semiconductor layer A, and a gate G. The source S and the drain D are connected to the semiconductor layer A. The gate G is disposed opposite to the semiconductor layer A. The electrode layer 120 is disposed on the active device layer 125. The electrode layer 120 includes at least one common electrode 121, at least one signal transmission line 410, and at least one pixel electrode 123. The pixel electrode 123 is electrically connected to the active device layer 125. The common electrode 121 is electrically connected to the signal transmission line 410 through a via hole 411. The common electrode 121 is electrically insulated from the pixel electrode 123. In this embodiment, there are plural common electrodes 121, plural signal transmission lines 410 and plural the pixel electrodes 123. In the embodiment of the present disclosure, the common electrode 121 is a driving electrode 121 opposite to the reference electrode 140 in a touch time interval, and is a common electrode 121 opposite to the pixel electrode 123 in a display time interval. Therefore, the common electrode 121 and the driving electrode 121 share the same reference numeral. In the touch time interval, the common electrode 12 refers to the driving electrode 121.

The display medium layer 130 is disposed between the first substrate 110 and the second substrate 170. In this embodiment, the display medium layer 130 includes liquid crystals. However, in other embodiments of the present disclosure, the display medium layer 130 may comprise organic light emitting diodes (OLEDs), mini light emitting diodes, micro light emitting diodes, quantum dots (QDs), fluorescent materials, phosphor materials, or combination thereof, or other display media.

The reference electrode 140 is disposed on the second substrate 170. The voltage applied to the reference electrode 140 may be originated from the component disposed on the first substrate 110; for example, the reference electrode 140 is electrically connected to the active device layer 125. In another embodiment of the present disclosure, the voltage applied to the reference electrode 140 is originated from the component disposed on the second substrate 170, while the present disclosure is not limited thereto. As shown in FIG. 1, there is a capacitance Cp formed between the reference electrode 140 and the common electrode 121 of the electrode layer 120. When a finger touches or applies force on the second substrate 170, the value of the capacitance Cp is changed because of the finger touch, or because the cell gap between the first substrate 110 and the second substrate 170 is decreased. Therefore, the capacitances Cp sensed at the common electrodes 121 of different positions may vary from one to another, making it possible to detect the magnitude of the force or the touch position.

The black matrix layer 160 is disposed on the second substrate 170. The color filter layer 150 is disposed on the black matrix layer 160. However, in other embodiments of the present disclosure, the black matrix layer 160 or the color filter layer 150 may be disposed on the first substrate 110.

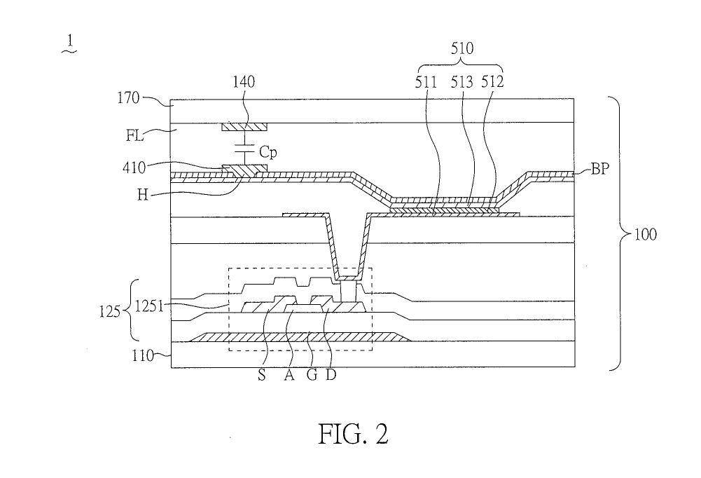

FIG. 2 is another schematic structural diagram of the touch display device 1 in accordance with the present disclosure. As shown in FIG. 2, in the embodiment where the display medium layer 510 of the touch display panel 100 is an organic light emitting diode layer or an inorganic light emitting diode layer, the second substrate 170 is a protective cover plate, and an encapsulation layer (not shown) is further provided on the display medium layer 510. The encapsulation layer may be an inorganic/organic/inorganic composite layer, but the present disclosure is not limited thereto. A flexible layer (FL) may be disposed between the first substrate 110 and the second substrate 170. The flexible layer FL is, for example, an air layer which may include nitrogen or inert gas, a flexible material layer which may include, but not limited to, optical adhesive (OCA/LOCA), optical clear resin (OCR), optical elasticity resin (SVR), silica gel or polyimide (PI), or an inorganic/organic/inorganic composite layer. In the present disclosure, the flexible layer FL is made of material that is deformable and restorable, and is not limited thereto. The reference electrode 140 is disposed on an upper surface or a lower surface of the second substrate 170. In addition, the black matrix layer 160 and the color filter layer 150 may be omitted or retained depending on the actual requirement. The organic light emitting diode or inorganic light emitting diode includes an anode 511, a light emitting layer 512 and a cathode 513, wherein the cathode 513 may be patterned to serve as the driving electrode 121. That is, in the touch time interval, the cathode 513 refers to the driving electrode 121. In addition, each of the patterned driving electrodes 121 is electrically connected to a corresponding one of the plurality of signal transmission lines 410, and an insulating layer BP is optionally disposed between the signal transmission lines 410 and the driving electrodes 121.

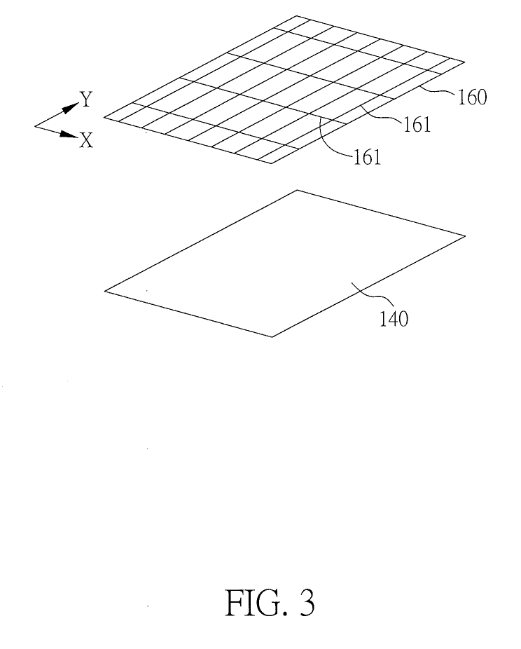

FIG. 3 is a schematic diagram illustrating the reference electrode and the black matrix layer in accordance with the present disclosure. As shown in FIG. 3, the black matrix layer 16 has a plurality of light shielding lines 161. The plurality of light shielding lines 161 are arranged along a first direction X and a second direction Y. The first direction X is substantially perpendicular to the second direction Y. The reference electrode 140 is a transparent conductive electrode. The transparent conductive electrode may include indium tin oxide (ITO), zinc tin oxide (ZTO), or indium zinc oxide (IZO).

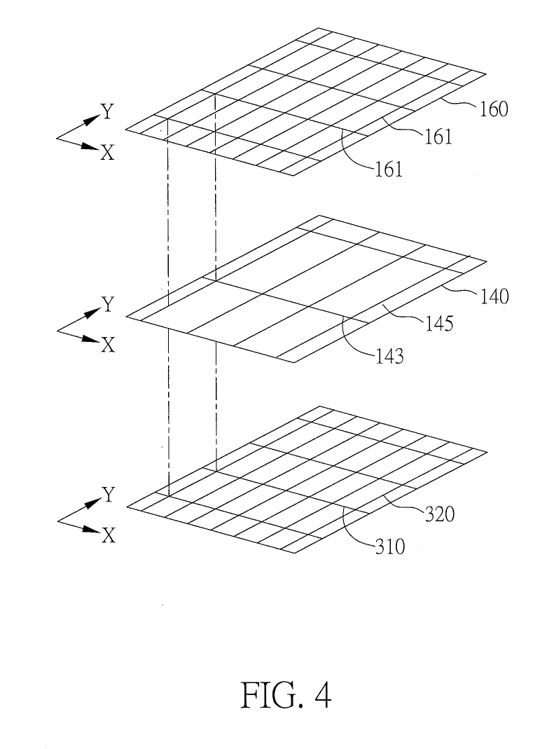

FIG. 4 is another schematic diagram illustrating the reference electrode and the black matrix layer in accordance with the present disclosure. The active device layer 125 further includes at least one gate line (GL) 310 and at least one data line (DL) 320. In this embodiment, there are a plurality of gate lines 310 and a plurality of data lines 320. The light shielding lines 161 of the black matrix layer 160 are disposed corresponding to the gate lines 310 and the data lines 320. The gate lines 310 are disposed on the first substrate 110 and extend in the first direction X. The data lines 320 are disposed on the first substrate 110 and extend in the second direction Y. That is, the light shielding lines 161 parallel to the first direction X correspond to the gate lines 310, and the light shielding lines 161 parallel to the second direction Y correspond to the data lines 320.

As shown in FIG. 4, the reference electrode 140 includes at least one first reference electrode 143 and at least one second reference electrode 145. In this embodiment, there are a plurality of first reference electrodes 143 and a plurality of second reference electrodes 145. The plurality of first reference electrodes 143 are disposed corresponding to the gate lines 310, and the plurality of second reference electrodes 145 are disposed corresponding to the data lines 320. In other words, the first reference electrodes 143 are parallel to the gate lines 310, and the second reference electrodes 145 are parallel to the data lines 320. In addition, the number of the first reference electrodes 143 may be equal to or different from that of the gate lines 310, and the number of the second reference electrodes 145 may be equal to or different from that of the data lines 320. In this embodiment, the number of first reference electrodes 143 is less than that of gate lines 310, and the number of second reference electrodes 145 is less than that of data lines 320. The plurality of first reference electrodes 143 are electrically connected to the second reference electrodes 145. The positions of the first reference electrodes 143 and the second reference electrodes 145 correspond to those of the plurality of light shielding lines 161. Therefore, the first reference electrodes 143 and the second reference electrodes 145 can be transparent or opaque.

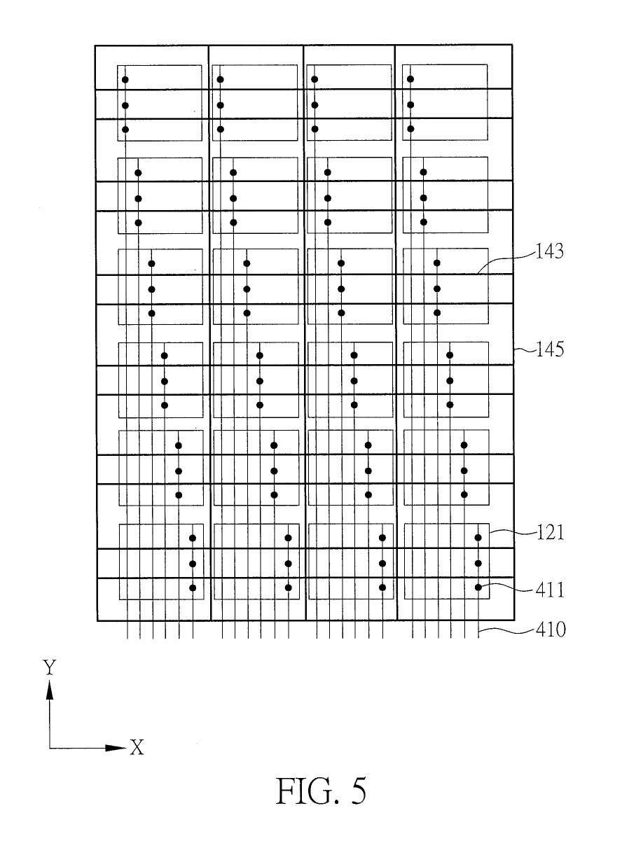

FIG. 5 is a schematic diagram illustrating the reference electrode and the common electrode in accordance with the present disclosure. With reference to FIG. 1 and FIG. 5, as shown, the common electrode 121 is electrically connected to a signal transmission line 410 through a via hole 411 so as to transmit the signal sensed by the common electrode 121. In FIG. 5, when the number of the second reference electrodes 145 parallel to the data lines is increased, the impedance of the reference electrode 140 can be reduced, so as to improve the accuracy of the touch detection. However, when the touch detection is performed, because of the voltage difference, the first reference electrode 143 and the second reference electrode 145 will generate a vertical electric field and a horizontal electric field with respect to the common electrode 121, which affect the rotation of liquid crystals and result in undesired optical phenomenon such as light leakage.

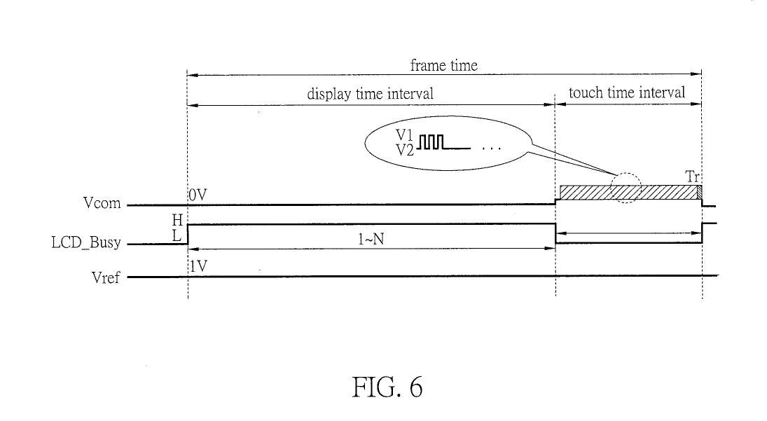

FIG. 6 schematically illustrates a first timing diagram for display and touch in accordance with the present disclosure. It should be noted that the numerical values used in various embodiments are for illustrative purpose only but not intended to be limiting of the present disclosure. In FIG. 6, the frame time is divided into a display time interval and a touch time interval. In the case where the update frequency of the frame is 60 Hz, one frame time is approximately 16.6 milliseconds (ms). In each embodiment, LCD_Busy being H represents that 1˜N gate lines are turned on to perform a display operation, and LCD_Busy being L represents that the gate lines are turned off to stop the display operation. It should be noted that LCD_Busy does not refer to an actual signal. In the display time interval, the touch display panel 100 performs a display operation. At this moment, the signal Vcom applied to the plurality of common electrodes 121 is at a low voltage, for example, 0V, so as to form an electric field with respect to the pixel electrode 123, which drives the display medium layer 130, such as liquid crystals, to rotate thereby performing a display operation. On the other hand, the reference voltage Vref applied to the reference electrode 140 in the display time interval is equivalent to the first reference voltage Vref1, and reference voltage Vref applied to the reference electrode 140 in the touch time interval is equivalent to the second reference voltage Vref2. Therefore, in this embodiment, the first reference voltage Vref1 is the same as the second reference voltage Vref2, and the reference voltage Vref is a DC voltage. In the touch time interval, the reference electrode 140 is provided with the first reference voltage Vref1 and, in the display time interval, the reference electrode 140 is provided with the second reference voltage Vref2.

In the touch time interval, the touch display panel 100 performs a touch operation. At this moment, the reference voltage Vref applied to the reference electrode 140 is 1V, which is different from the voltage of the common electrode 121 in the display time interval, and is greater than the ground voltage. The touch drive signal applied to the plurality of common electrodes 121 is a square wave composed of V1 and V2, wherein V1 is 4V and V2 is 1V, so as to form an electric field with respect to the reference electrode 140 thereby performing a touch detection operation. In the touch time interval, the root mean square (RMS) voltage of the touch drive signal is calculated to be about 2.9V.

As shown in FIG. 6, in the touch time interval, the touch drive signal applied to the common electrode 121 causes the common electrode 121 to be alternatively provided with a first voltage V1 and a second voltage V2. The first voltage V1 is a positive voltage and the second voltage V2 is a positive voltage different from the first voltage V1. The first voltage V1 is greater than the reference voltage Vref of the reference electrode 140, and the second voltage V2 is less than or equal to the reference voltage Vref of the reference electrode 140. In the touch time interval, by reducing the voltage difference between the reference voltage Vref of the reference electrode 140 and the root mean square voltage applied to the common electrode 121, the electric field intensity between the reference electrode 140 and the common electrode 121 can be reduced, thereby alleviating the light leakage phenomenon of liquid crystals.

As shown in FIG. 6, in the touch time interval, the touch drive signal of the common electrode 121 is a V1-to-V2 square wave. In other embodiments, the touch drive signal may be a sine wave or a triangular wave. The root mean square voltage of the touch drive signal is about 2.9V, and the voltage of the reference electrode 140 is 1V. In the touch time interval, the voltage difference between the reference voltage Vref of the reference electrode 140 and the root mean square voltage of the common electrode 121 is about 1.9V. That is, by reducing the voltage difference between the reference electrode 140 and the common electrode 121, the light leakage phenomenon of liquid crystals can be alleviated.

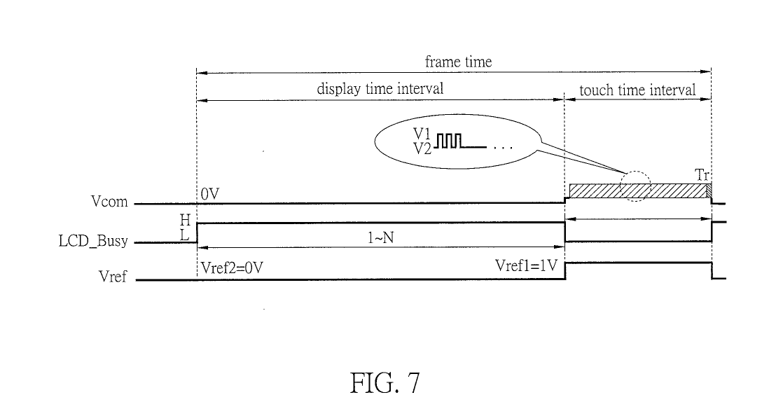

FIG. 7 schematically illustrates a second timing diagram for display and touch in accordance with the present disclosure, which is similar to FIG. 6 except that: the voltage applied to the reference electrode 140 is an AC voltage. In the touch time interval, the first reference voltage Vref1 is applied to the reference electrode 140 and, in the display time interval, the second reference voltage Vref2 is applied to the reference electrode 140, wherein the first reference voltage Vref1 is 1V and the second reference voltage Vref2 is 0V. The second reference voltage Vref2 is a ground voltage, and the second reference voltage Vref2 is less than the first reference voltage Vref1. In the display time interval, the reference electrode 140 and the plurality of common electrodes 121 are substantially of the same voltage level, so that the magnitude of the electric field between the reference electrode 140 and the common electrodes 121 does not affect the rotation of liquid crystals, and thus it does not affect the display operation in the display time interval. Moreover, in the touch time interval, the voltage of the reference electrode 140 is increased to reduce the voltage difference between the reference electrode 140 and the common electrode 121, thereby alleviating the light leakage phenomenon of liquid crystals.

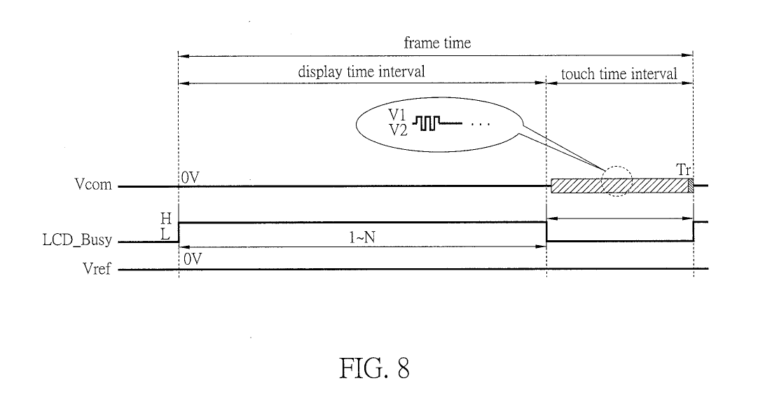

FIG. 8 schematically illustrates a third timing diagram for display and touch in accordance with the present disclosure, which is similar to FIG. 7 except that: the reference voltage Vref applied to the reference electrode 140 is a DC voltage and the reference voltage Vref is 0V (i.e., a ground voltage) in the frame time, and the Vcom voltage is 0V in the display time interval. In the touch time interval, the touch drive signal Vcom applied to the common electrode 121 is alternatively provided with a first voltage V1 and a second voltage V2. The first voltage V1 is a positive voltage and the second voltage V2 is a negative voltage. That is, V1 and V2 satisfy the condition of |V1−V2|≥|V1|−|V2|, where V1 is 1.5V and V2 is −1.5V. On the other hand, the difference between the first voltage V1 and the first reference voltage Vref is equal to the difference between the first reference voltage Vref and the second voltage V2.

Because the touch drive signal is an alternating positive/negative voltage signal, it can reduce the root mean square (RMS) voltage. By reducing the root mean square voltage, the voltage difference between the reference electrode 140 and the common electrode 121 can be reduced so as to alleviate the light leakage phenomenon of liquid crystals. In the touch time interval, the square root voltage of the reference electrode 140 is 1.5V, and the voltage difference between the reference electrode 140 and the common electrode 121 is further reduced to 1.5V, so as to further alleviate the light leakage phenomenon of liquid crystals.

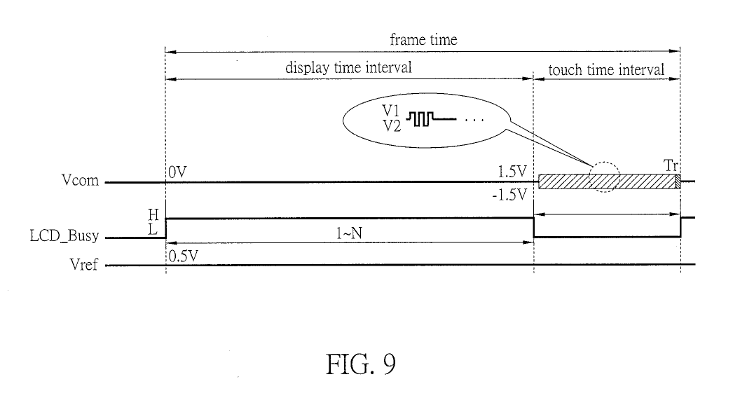

FIG. 9 schematically illustrates a fourth timing diagram for display and touch in accordance with the present disclosure, which is similar to FIG. 8 except that: the reference voltage Vref applied to the reference electrode 140 is not 0V in the frame time, wherein the reference voltage Vref is 0.5V, and the Vcom voltage is 0V in the display time interval. In the touch time interval, the root mean square (RMS) voltage of the touch drive signal is 1.5V, and the reference voltage Vref is 0.5V. Accordingly, the voltage difference between the reference electrode 140 and the common electrode 121 can be reduced to 1V, so as to alleviate the light leakage phenomenon of liquid crystals.

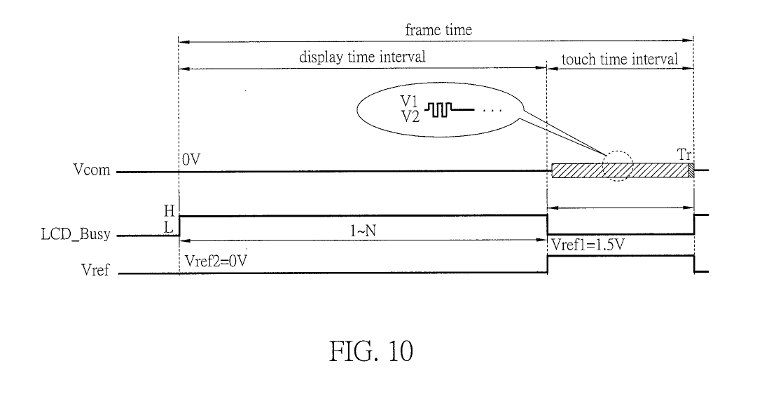

FIG. 10 schematically illustrates a fifth timing diagram for display and touch in accordance with the present disclosure, which is similar to FIG. 9 except that: the voltage applied to the reference electrode 140 is an AC voltage. In the touch time interval, a first reference voltage Vref1 is applied to the reference electrode 140 and, in the display time interval, a second reference voltage Vref2 is applied to the reference electrode 140, wherein the first reference voltage Vref1 is 1.5V and the second reference voltage Vref2 is 0V. In the display time interval, the second reference voltage Vref2 applied to the reference electrode 140 is equal to the Vcom voltage. In the touch time interval, the first reference voltage Vref1 applied to the reference electrode 140 is close to the root mean square voltage of the touch drive signal, wherein the root mean square voltage is 1.5V. That is, in the touch time interval, the voltage difference between the first reference voltage Vref1 of the reference electrode 140 and the root mean square voltage of the common electrode 121 is 0V, which can alleviate the light leakage phenomenon of liquid crystals.

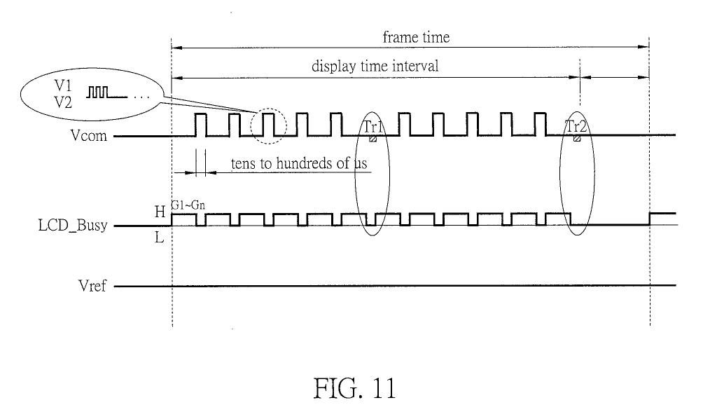

FIG. 11 schematically illustrates a sixth timing diagram for display and touch in accordance with the present disclosure, which is similar to FIG. 10 except that the timing diagram for display and touch in FIG. 11 shows the touch time interval being interleaved with the display time interval.

As shown in FIG. 11, the reference voltage Vref applied to the reference electrode 140 is 0.5V. When LCD_Busy signal is H, it indicates that the touch display panel 100 performs a display operation. When LCD_Busy signal is L, the touch drive signal applied to the plurality of common electrodes 121 is a square wave of V1 to V2. That is, when LCD_Busy signal is L, the touch detection operation is performed.

For example, the first LCD_Busy signal being H is labeled with G1˜Gn to indicate that the touch display panel 100 turns on the first to n-th gate lines for performing the display operation. Then, the LCD_Busy signal becomes L for a period of approximately tens to hundreds of microseconds (μs). However, this period of time is only an example and is not intended to be limiting of the present disclosure. At this moment, the touch drive signal applied to the plurality of common electrodes 121 is a square wave of V1 to V2 for performing the touch detection operation. In FIG. 6, in the time interval Tr, the touch control chip performs data processing (for example, point reporting). Similarly, in FIG. 11, in the time interval Tr1 and the time interval Tr2, the touch control chip performs data processing (for example, point reporting). In the embodiment of FIG. 6, the point reporting rate is 60 Hz and, in the embodiment of FIG. 11, the point reporting rate is 120 Hz.

In view of the foregoing description, it is known that the present disclosure reduces the voltage difference between the reference electrode 140 and the common electrode 121 by adjusting the reference voltage Vref applied to the reference electrode 140 and the root mean square voltage applied to the common electrode 121, so as to reduce the electric field intensity between the reference electrode 140 and the common electrode 121 thereby alleviating the light leakage phenomenon of liquid crystals.

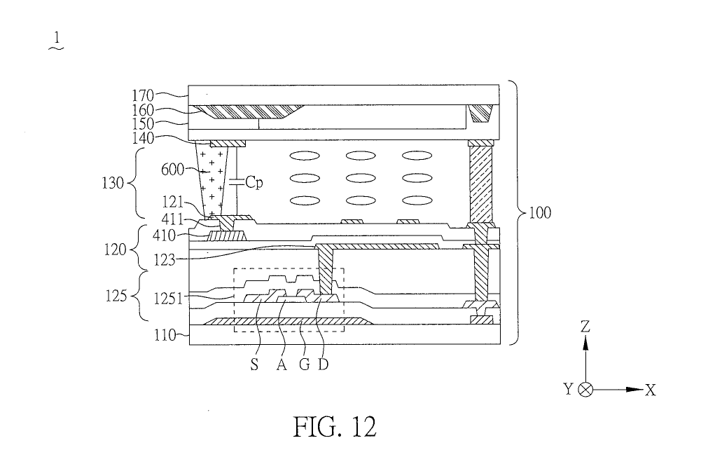

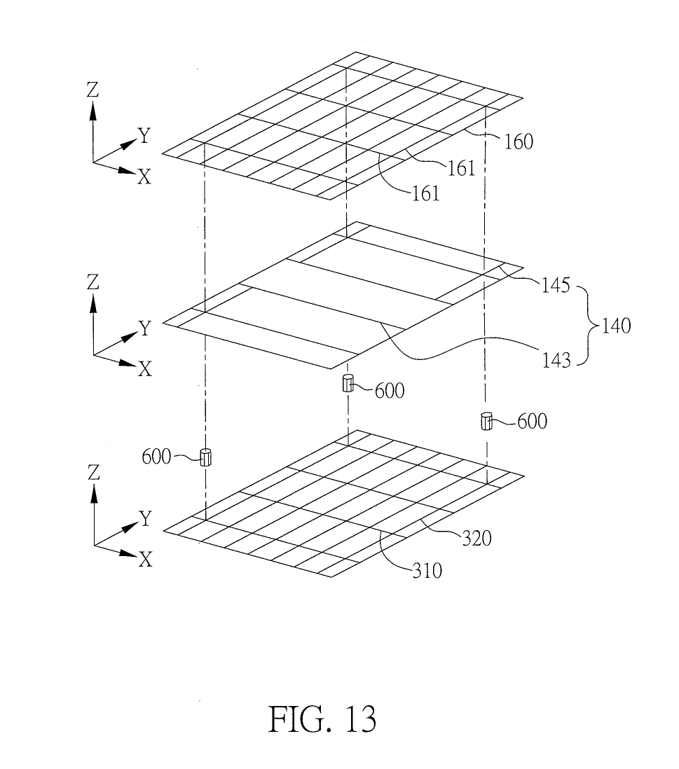

When the number of the second reference electrodes 145 parallel to the data lines is increased, the impedance of the reference electrode 140 can be reduced. However, the panel may encounter light leakage problem in some cases. In this regard, the present disclosure can solve this problem by providing different arrangements of the reference electrode 140. With reference to FIG. 12 and FIG. 13 at the same time, FIG. 12 is still another schematic structural diagram of the touch display device 1 in accordance with the present disclosure, and FIG. 13 is still another schematic diagram illustrating the reference electrode 140 and the black matrix layer 160 in accordance with the present disclosure. Similar to the structure of the previous embodiments, the touch display device 1 of this embodiment also includes: a first substrate 110, a second substrate 170 disposed opposite to the first substrate 110, a display medium layer 130 disposed between the first substrate 110 and a second substrate 170, a reference electrode 140 disposed on the second substrate 170, and an active device layer 125 disposed on the first substrate 110 and including at least one gate line 310 and at least one data line 320. The touch display device 1 of this embodiment may further include an electrode layer 120, a color filter layer 150, and a black matrix layer 160, while it is not limited thereto. In addition, the reference electrode 140 in this embodiment is divided into first reference electrodes 143 (shown in FIG. 13) and second reference electrodes 145 (shown in FIG. 13), and the first reference electrodes 143 are disposed corresponding to the gate lines 310 and the second reference electrodes 145 are disposed corresponding to the data lines 320 (shown in FIG. 13). Since the details of some of the components have been described in detail in the previous embodiments, the following only describes the portion of the present embodiment that is different from the previous embodiment.

As shown in FIG. 12, the touch display device 1 of this embodiment further includes at least one spacer unit 600 disposed on the first substrate 110 or the second substrate 170, which can keep the distance between the first substrate 110 and the second substrate 170 and support the thickness of the display medium layer 130. The spacer unit 600 may be a photo spacer, but is not limited thereto.

Next, the arrangement of the reference electrode 140 will be described. FIG. 13 mainly illustrates the possible corresponding positions of the gate lines 310, the data lines 320, the reference electrode 140, the black matrix layer 160, and the spacer units 600 on the XY plane, while the arrangement of the aforementioned components in the Z direction is for illustrative purpose only. In addition, the number of the aforementioned components is also for illustrative purpose only, and is not intended to be limiting of the disclosure. In this embodiment, the reference electrode 140 is divided into a plurality of first reference electrodes 143 and a plurality of second reference electrodes 145, wherein the first reference electrodes 143 can be electrically connected to the second reference electrodes 145. The first reference electrodes 143 are disposed corresponding to the gate lines 310; that is, the first reference electrodes 143 are disposed parallel to the gate lines 310. The second reference electrodes 145 are disposed corresponding to the data lines 320; that is, the second reference electrodes 145 are disposed parallel to the data lines 320. In this embodiment, the number of the second reference electrodes 145 is less than that of data lines 320; that is, there are second reference electrodes 145 corresponding to some of the data lines 320, and there is no second reference electrode 145 corresponding to the remaining data lines 320. The number of the first reference electrodes 143 is not limited in comparison with the number of the gate lines 310. In addition, in this embodiment, the black matrix layer 160 has a plurality of light shielding lines 161, and the spacer units 600, and the second reference electrodes 145 are disposed corresponding to some of the light shielding lines 161. A second reference electrode 145 is electrically connected to some of the first reference electrodes 143. The reference electrodes 140 are electrically connected to the active device layer 125. In one embodiment, the second reference electrodes 145 are disposed at positions of some of the light shielding lines 161 corresponding to the spacer units 600, while it is not limited thereto. In addition, the first reference electrodes 143 and the second reference electrodes 145 are transparent or opaque. In another embodiment, the second reference electrodes 145 are electrically insulated from some of the first reference electrodes 143. In the following, more embodiments will be given to describe the arrangement of the light shielding lines 161, the spacer units 600, the second reference electrodes 145 and the data lines 320.

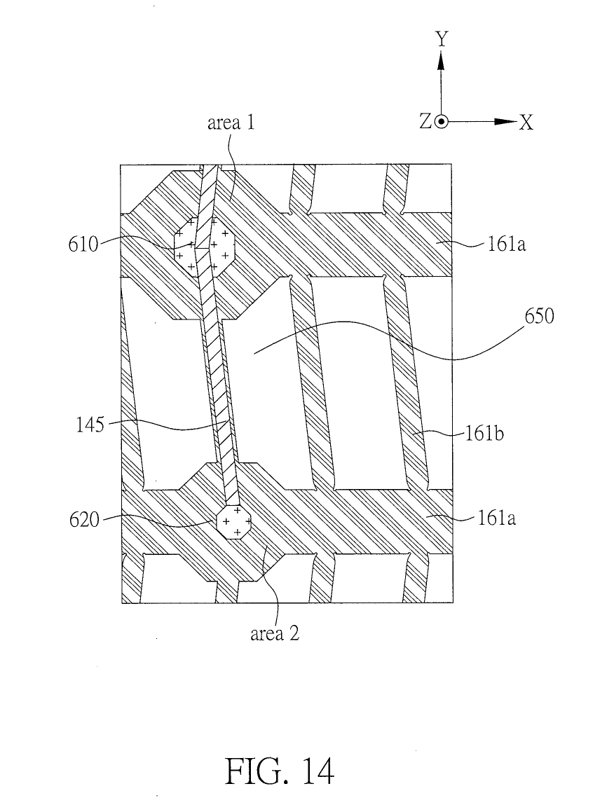

The arrangement of the light shielding lines 161, the spacer units 600, the second reference electrodes 145 and the data lines 320 will be described in more detail below. FIG. 14 is a schematic diagram illustrating the light shielding lines, the spacer units, the second reference electrodes and the data lines corresponding to the Z direction (corresponding to the display surface of the touch display device 1) in accordance with an embodiment of the present disclosure. The Z direction of FIG. 14 is defined to be a direction from the first substrate 110 toward the second substrate 170. Please refer to FIGS. 12 to 14 at the same time. As shown in FIG. 14, the spacer units 600 are divided into first spacer units 610 and second spacer units 620. The light shielding lines include first light shielding lines 161a and second light shielding lines 16 lb. In addition, the light shielding lines and the data lines may define the opening areas of the sub-pixel units 650. In FIG. 14, the data lines (not shown) overlap the light shielding lines extending in the Y direction. In this embodiment, there is a first area, denoted as area1, defined as a region of the first light shielding line 161a corresponding to the first spacer unit 610, and there is a second area, denoted as area2, defined as a region of the second light shielding line 161b corresponding to the second spacer unit 620, wherein the first area areal is greater than the second area area2. That is, the position of the first spacer unit 610 corresponds to a greater light shielding area, and thus the sub-pixel units 650 around the first spacer unit 610 may have a smaller aperture ratio than the sub-pixels 650 at other positions. In one embodiment, the first spacer unit 610 may be a main spacer unit (main-PS) and the second spacer unit 620 may be a subsidiary spacer unit (sub-PS), while it is not limited thereto. In addition, the second reference electrode 145 is disposed along with the first spacer unit 610. For example, the second reference electrode 145 is disposed corresponding to at least one data line neighboring the first spacer unit 610 without corresponding to all of the data lines, while it is not limited thereto. In this way, by arranging the second reference electrode 145 along the data line neighboring the first spacer unit 610 without corresponding to all of the data lines, not only the impedance of the reference electrode 140 can be decreased, but also the influence to the brightness of the display panel caused by disposing the second reference electrode 145 can be greatly reduced because the position of the first spacer unit 610 corresponds to a greater light shielding area (the aperture ratio of the surrounding sub-pixel unit 650 being smaller).

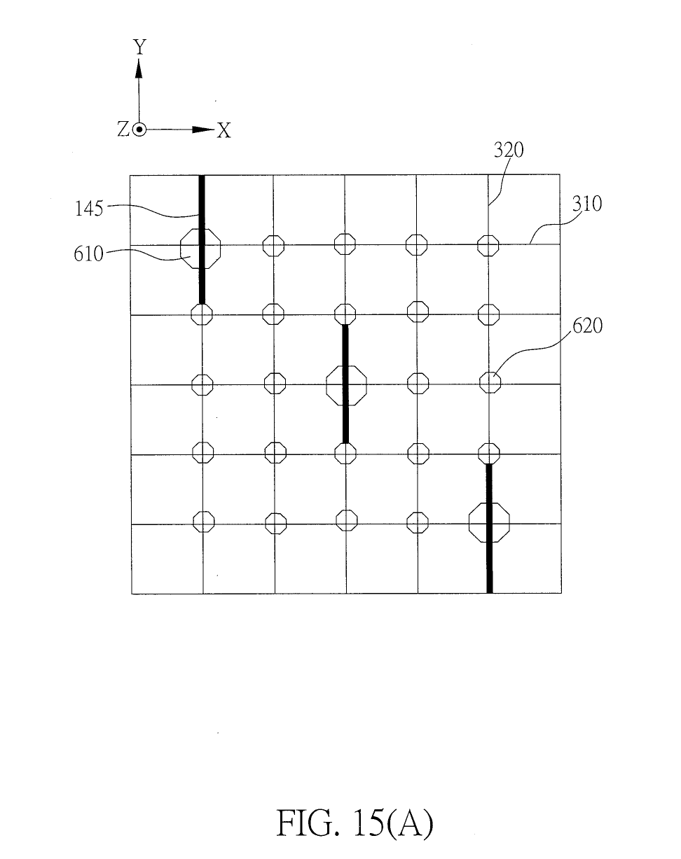

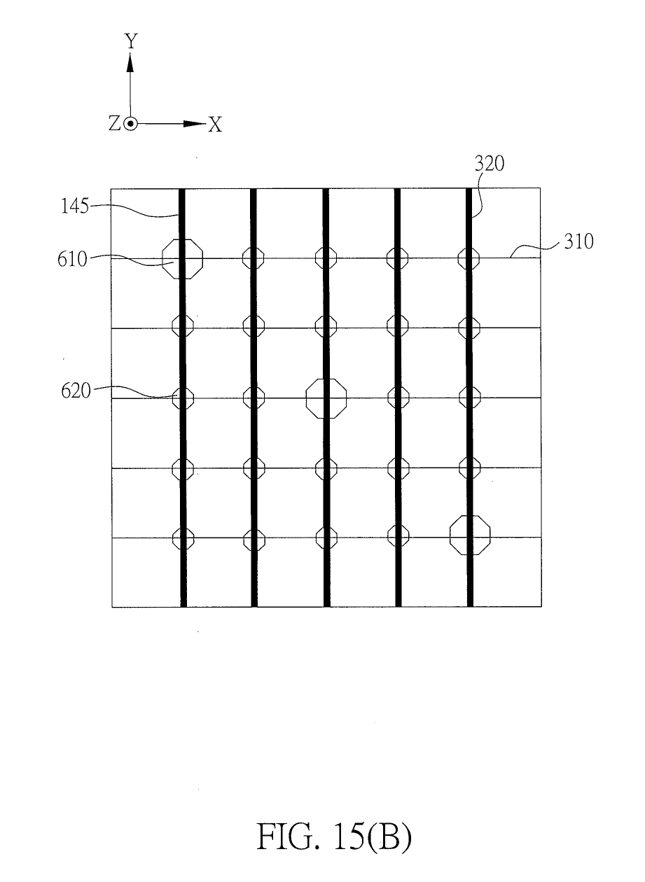

In addition, the second reference electrodes 145 may be arranged in various manners. Please refer to FIG. 12 to FIG. 15(B) at the same time. FIG. 15(A) is a schematic diagram illustrating the arrangement of the second reference electrodes in accordance with an embodiment of the present disclosure, which is an extension based on the embodiment of FIG. 14. This embodiment is only provided to describe the arrangement of the second reference electrodes 145 on the XY plane, while the size, number and shape of each component are for illustrative purpose only and the details thereof are not shown. For example, the arrangement of the first reference electrodes 143 on the XY plane is not shown, and the shape of the second reference electrode 145 is for illustrative purpose only and is not intended to be limiting of the present disclosure. As shown in FIG. 15(A), the touch display device 1 includes a plurality of first spacer units 610 and a plurality of second spacer units 620, and the second reference electrode 145 is disposed along with the first spacer unit 610, indicating that there is a second reference electrode 145 disposed corresponding to the data line 320 neighboring the first spacer unit 610, and there is no second reference electrode 145 disposed corresponding the data line 320 neighboring the second spacer unit 620. In this embodiment, the number of the first spacer units 610 is less than the number of the second spacer units 620, but it is not limited thereto. In addition, in one embodiment, the ratio of the number of the first spacer units 610 to the number of the sub-pixel units 650 is 1:60, but it is not limited thereto.

FIG. 15(B) is a schematic diagram illustrating the arrangement of the second reference electrodes 145 in accordance with another embodiment of the present disclosure, which is also an extension based on the embodiment of FIG. 14. This embodiment is only provided to describe the arrangement of the second reference electrodes on the XY plane, while the size, number and shape of each component are for illustrative purpose only and the details thereof are not shown. For example, the arrangement of the first reference electrodes 143 on the XY plane is not shown, and the shape of the second reference electrode 145 is for illustrative purpose only and is not intended to be limiting of the present disclosure. As shown in FIG. 15(B), the touch display device 1 includes a plurality of first spacer units 610 and a plurality of second spacer units 620, and part of the second reference electrode 145 is disposed along the first spacer unit 610 and part of the second reference electrode 145 is disposed along the second spacer units 620. That is, except that the data line 310 neighboring the first spacer unit 610 has the second reference electrode 145 corresponding thereto, the data line 310 neighboring the second spacer unit 620 also has the second reference electrode 145 corresponding thereto. The second reference electrode 145 may be disposed along some of the second spacer units 620, but may also be disposed along all of the second spacer units 620. In addition, the second reference electrodes 145 are not limited to being disposed along all the first spacer units 610. Besides, the number of the first spacer units 610 and the number of the second spacer units 620 are not limited.

In addition, in the embodiments of FIGS. 15(A) and 15(B), the data lines 320 are perpendicular to the gate lines 310, and thus the second reference electrodes 145 disposed in parallel to the data lines are also perpendicular to the first reference electrodes 143 disposed parallel to the gate lines 310. However, in other embodiments, the data lines 320 may not be perpendicular to the gate lines 310; that is, the angle formed between a data line 320 and a gate line 310 is not a right angle. In this case, the angle formed between a second reference electrode 145 parallel to the data lines 320 and a first reference electrode 143 parallel to the gate lines 310 is also not a right angle, while it is not limited thereto.

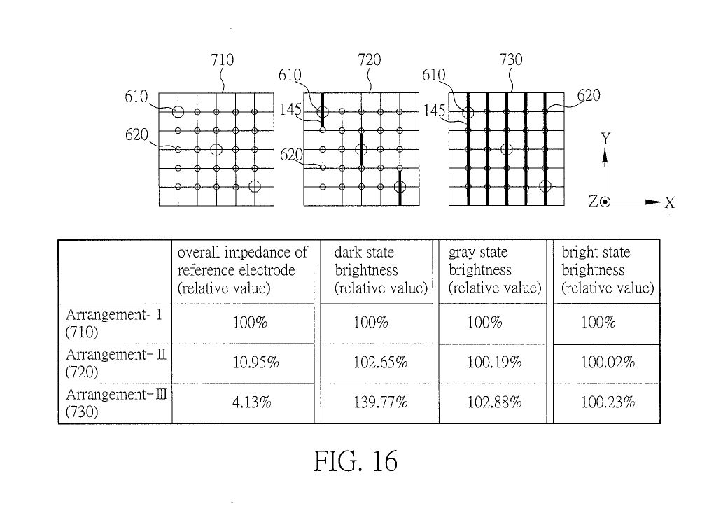

The influence of the arrangement of the second reference electrodes 145 on the impedance of the reference electrode 140 (not shown in FIG. 16) will be described below with an embodiment. FIG. 16 is a diagram illustrating a comparison between the overall impedance and brightness under different arrangements of the second reference electrodes. Please refer to FIG. 12 to FIG. 16 at the same time. In this embodiment, a comparison is made among an arrangement-I 710 (there are first reference electrodes 143 only, and no second reference electrode 145), an arrangement-II 720 (there are first reference electrodes 143 and second reference electrodes 145, and the second reference electrode 145 is disposed along with the first spacer unit 610), and an arrangement-III 730 (the second reference electrode 145 is disposed corresponding to all of the data lines 320), wherein the difference among the arrangement-I 710, the arrangement-II 720 and the arrangement-III 730 is the number of the second reference electrodes 145. In addition, in the arrangement-II 720, the ratio of the number of first spacer units 610 (for example, main spacer units) to the number of sub-pixel units is 1:60, but it is not limited thereto. As shown in FIG. 16, if the overall impedance of the reference electrode 140 of the arrangement-I 710 is defined as 100%, the overall impedance of the reference electrode 140 of the arrangement-II 720 is about 10.95%, and the overall impedance of the reference electrode 140 of the arrangement-III 730 is about 4.13%. It can be seen that, with the arrangement-II 720 and the arrangement-III 730, the overall impedance of the reference electrode 140 can be greatly reduced. It should be noted that this embodiment is provided for illustrative purpose only and, in actual application, the parameters such as the number of electrodes and the arrangement of electrodes are not limited thereto. In different measurement environments, the impedances of the aforementioned architectures may also be different.

Please refer to FIG. 16 again. For the dark state brightness (for example, gray level value is 0), when the overall dark state brightness of the arrangement-I 710 is defined as 100%, the overall dark state brightness of the arrangement-II 720 is about 102.65%, and the overall dark state brightness of the arrangement-III 730 is about 139.77%. It can be seen that the overall dark state brightness of the arrangement-II 720 (the second reference electrode 145 is disposed corresponding to part of the data line) does not differ dramatically from the overall dark state brightness of the arrangement-I 710 (there is no second reference electrode 145 disposed), and the overall dark state brightness of the arrangement-III 730 (the second reference electrode 145 corresponds to the entire data line) is significantly increased. For the gray state brightness (for example, gray level value is 127), when the overall gray state brightness of the arrangement-I 710 is defined as 100%, the overall gray state brightness of the arrangement-II 720 is about 100.19%, and the overall gray brightness of the arrangement-III 730 is about 102.88%. It can be seen that the overall gray state brightness of the arrangement-II 720 and arrangement-III 730 does not differ dramatically from the overall gray state brightness of the arrangement-I 710. For the bright state brightness (e.g. gray level value is 255), when the overall bright state brightness of arrangement-I 710 is defined as 100%, the overall bright state brightness of arrangement-II 720 is about 100.02%, and the overall bright state brightness of the arrangement-III 730 is about 100.23%. It can be seen that the overall bright state brightness of the arrangement-II 720 and arrangement-III 730 does not differ dramatically from the overall bright state brightness of the arrangement-I 710. It should be noted that this embodiment is provided for illustrative purpose only and, in actual application, the parameters such as the number of electrodes and the arrangement of electrodes are not limited thereto. In different measurement environments, the aforementioned brightness may also be different.

In addition, the touch display device 1 shown in FIGS. 12 to 16 may be driven by using the driving methods shown in FIGS. 6 to 11. For example, the touch display device 1 may include a driving electrode 121 disposed on the first substrate. In a touch time interval of a frame time, the reference electrode 140 is provided with a first reference voltage Vref1 and the driving electrode 121 is alternatively provided with a first voltage V1 and a second voltage V2, wherein the first voltage V1 is greater than the first reference voltage Vref1 and the second voltage V2 is less than or equal to the first reference voltage Vref1, while it is not limited thereto. The driving methods shown in FIGS. 6 to 11 have been described in previous paragraphs, and thus a detailed description therefor is deemed unnecessary. In addition, the touch display device 1 shown in FIGS. 12 to 16 is not limited to being driven by the driving methods shown in FIGS. 6 to 11.

In view of the foregoing description, it is known that, by way of arranging the second reference electrode corresponding to part of the data line but not corresponding to the entire data line (for example, the second reference electrode corresponds to the data line neighboring the main spacer unit), the overall impedance of the reference electrode can still be reduced, and the panel light leakage caused by the arrangement of the second reference electrodes can be reduced. However, if the second reference electrode is disposed corresponding to each data line, it still has a relatively small overall impedance, although the light leakage problem may be worse than the arrangement of the second reference electrode corresponding to part of the data line.

The touch display device manufactured in the aforementioned embodiments of the present disclosure may be applied to any electronic device that requires a display screen, such as a display device, a mobile phone, a notebook computer, a tablet computer, a watch, a VR display, a video camera, a camera, a music player, a mobile navigation device, a television, a car dashboard, a center console, an electronic rear-view mirror, a head-up display, and so on.

Although the present invention has been explained in relation to its preferred embodiment, it is understood that many other possible modifications and variations can be made without departing from the spirit and scope of the invention as hereinafter claimed.

What is claimed is:

1. A touch display device, comprising:
a first substrate;
a second substrate disposed opposite to the first substrate;
a display medium layer disposed between the first substrate and the second substrate;
a driving electrode disposed on the first substrate; and
a reference electrode disposed on the second substrate,
wherein, in a touch time interval of a frame time, the reference electrode is provided with a first reference voltage and the driving electrode is alternatively provided with a first voltage and a second voltage, where the first voltage is greater than the first reference voltage and the second voltage is less than or equal to the first reference voltage.

2. The touch display device as claimed in claim 1, wherein, in a display time interval of the frame time, the reference electrode is provided with a second reference voltage and the second reference voltage is equal to the first reference voltage.

3. The touch display device as claimed in claim 2, wherein the second reference voltage is a ground voltage.

4. The touch display device as claimed in claim 2, wherein the second reference voltage is greater than a ground voltage.

5. The touch display device as claimed in claim 1, wherein, in a display time interval of the frame time, the reference electrode is provided with a second reference voltage, and the second reference voltage is less than the first reference voltage.

6. The touch display device as claimed in claim 5, wherein the second reference voltage is a ground voltage.

7. The touch display device as claimed in claim 1, wherein a difference between the first voltage and the first reference voltage is equal to a difference between the first reference voltage and the second voltage.

8. The touch display device as claimed in claim 1, further comprising an active device layer disposed on the first substrate, and the active device layer including a gate line and a data line.

9. The touch display device as claimed in claim 8, wherein the reference electrode includes a first reference electrode and a second reference electrode, the first reference electrode is disposed corresponding to the gate line, and the second reference electrode is disposed corresponding to the data line.

10. The touch display device as claimed in claim 9, wherein the first reference electrode is electrically connected to the second reference electrode.

11. The touch display device as claimed in claim 9, wherein the reference electrode is electrically connected to the active device layer.

12. The touch display device as claimed in claim 9, wherein the display medium layer comprises a first spacer unit, and the second reference electrode is disposed corresponding to at least one data line neighboring the first spacer unit.

13. The touch display device as claimed in claim 12, further comprising a first light shielding line and a second light shielding line, wherein the display medium layer includes a second spacer unit, a first area is defined as a region of the first light shielding line corresponding to the first spacer unit, a second area is defined as a region of the second light shielding line corresponding to the second spacer unit, and the first area is greater than the second area.

14. The touch display device as claimed in claim 9, wherein the second reference electrode is disposed corresponding to part of the data line.

15. The touch display device as claimed in claim 13, wherein the first light shielding line and the second light shielding line are disposed corresponding to the gate line and the data line.

16. The touch display device as claimed in claim 13, wherein the first spacer unit and the second spacer unit are photo spacers.

17. The touch display device as claimed in claim 1, wherein the display medium layer comprises liquid crystals, organic light emitting diodes, mini light emitting diodes, micro light emitting diodes, quantum dots, fluorescent materials, phosphor materials, or combination thereof.

18. The touch display device as claimed in claim 1, further comprising a black matrix layer disposed on the second substrate.

19. The touch display device as claimed in claim 18, further comprising a color filter layer disposed on the black matrix layer.

20. The touch display device as claimed in claim 9, wherein the first reference electrode and the second reference electrode are transparent or opaque.
